(19) United States
(12) Patent Application Publication
(10) Pub. No.: US 2023/0169088 A1
(43) Pub. Date: Jun. 1, 2023

(54) METHOD AND SYSTEM FOR PRODUCING DATA VISUALIZATIONS VIA LIMITED BANDWIDTH COMMUNICATION CHANNELS

(71) Applicant: INSIGHT CREATIONS LLC, Cortlandt Manor, NY (US)

(72) Inventor: Richard Campos, Cortlandt Manor, NY (US)

(21) Appl. No.: 17/997,721

(22) PCT Filed: May 26, 2021
(86) PCT No.: PCT/US2021/070606

§ 371 Date: Nov. 1, 2022

Related U.S. Application Data
(60) Provisional application No. 63/030,569, filed on May 27, 2020.

(51) Int. Cl. G06F 16/26; G06F 16/22

(52) U.S. Cl. CPC G06F 16/26; G06F 16/2282; H04L 51/10

(57) ABSTRACT

A method and system for producing data visualizations via limited bandwidth data channels Table data is provided in a text string compliant with a minimal predefined protocol suitable for the limited bandwidth data messaging channel and without requiring the table geometry to be specified. The message is parsed and table data processed to reconstruct the table geometry based on the table data. A graphical representation of the table data is generated in accordance with the reconstructed table geometry. The graphical representation or means to remotely access is returned to the requesting device.

### CROSS-REFERENCE TO RELATED APPLICATIONS

This application claims priority to U.S. Provisional Application Ser. No. 63/030,569 filed May 27, 2020, the entire contents of which is expressly incorporated by reference.

### FIELD OF THE INVENTION

The present invention relates to a method and system for remotely producing data visualizations suitable for use in a limited bandwidth communication network.

### BACKGROUND

In current systems for data analysis, data analytics software products or services are licensed to or subscribed by individuals or their organizations. Examples of software products or related services include electronic spreadsheets, data visualization tools and business intelligence platforms. The present art requires significant know-how and programming effort before a user obtains analysis results in the form of summaries or charts. This effort is needed both on the data aggregation side, requiring specific relational database programming expertise, and on the data analysis side, where the user must build and test the programming logic for every use case.

Each analysis, along with its work products including text summaries and charts, are then stored in proprietary electronic files such as spreadsheets or workbooks. Typically, recipients share these files via electronic mail services. This kind of distribution is both storage and time intensive because of content bundling, communication delay, and click-through effort needed to access the content. In many cases a user may want to do numeric analysis and data visualization without having to install or learn such applications programs.

In addition, conventional software, such as spreadsheets, can be difficult to use in a collaborative environment in which one user can easily share a visualization with another and multiple users can easily update the visualization, such as by changing the data. Each user needs to have the same software installed and know how to use it.

By their nature, spreadsheets and worksheets can include combined work products from different people, making it difficult to trace and audit the workflows involved. The widely variable nature of the format and content of files in such conventional software, including and the many different data analyses functionalities embedded therein, also make it difficult to use the files for other purposes. These purposes can include trend analysis and as a source of clean data sets of single-purpose user requests for use in training AI systems to assist in prediction of typical function requests types and presentation formats given past selections.

There is a need to provide a more effective and efficient form of analysis with a system and method that facilitates a remote data analysis system that can be accessed by a user of a limited capability computing device. While remote cloud-based software as a service (SAAS) systems are available, they require a high-speed and reliable broad band internet connection. Such systems are unsuitable for use on devices which may be operating in low or limited bandwidth environments, such as a cellular device in a limited service area and which may have restricted data service that might be limited to text messaging. There is a further need for such a system that can be easily used in both an individual and a collaborative environment.

### DESCRIPTION OF THE DRAWINGS

Further features and advantages of the invention, as well as structure and operation of various implementations of the invention, are disclosed in detail below with references to the accompanying drawings in which:

FIG. 1 is a high-level diagram of a system for producing data visualizations as disclosed herein;

FIG. 2 is an exemplary a nested semantic tree defining aspects of a message content protocol for use by the present system;

FIG. 3a is an example of a table of source data;

FIGS. 3b and 3c illustrate atomic container body text that includes content of FIG. 3a and requests a visualization thereof according to an implementation of the protocol of FIG. 2;

FIG. 3d is an example chart that can be generated by the system in response to receiving a container as set forth in FIG. 3b or 3c;

FIG. 4 is a simplified block diagram of components in an embodiment of the server of FIG. 1;

FIG. 5 is high-level flow diagram of the server functionality responsive to visualization requests from a user device;

FIG. 6 is a high-level flowchart of the operation of the workflow processor of FIG. 4;

FIG. 7 is a high-level flowchart of the operation of the parsing engine of FIG. 4;

FIG. 8 is a high-level flow chart of the training and use of an AI system to fill in missing elements of a received container;

FIG. 9 is a high-level flowchart of a method of reconstructing table geometry according to an embodiment;

FIGS. 10a-10c are illustrations of aspects of a reconstruction process for a first example set of table data;

FIGS. 11a-11c are illustrations of aspects of a reconstruction process for a second example set of table data;

FIG. 12 is a simplified block diagram of components in an embodiment of the user device of FIG. 1;

FIG. 13 is a high-level flow diagram of operation of the user device in generating a relevant communication to the server;

FIGS. 14a-14d are screen displays of a guided process to build a request to the server;

FIG. 14e is an example visualization responsive to the request of FIGS. 14a-14d; and

FIG. 15 is an illustration of a sample data structure for storing atomic container data and related information.

### DETAILED DESCRIPTION

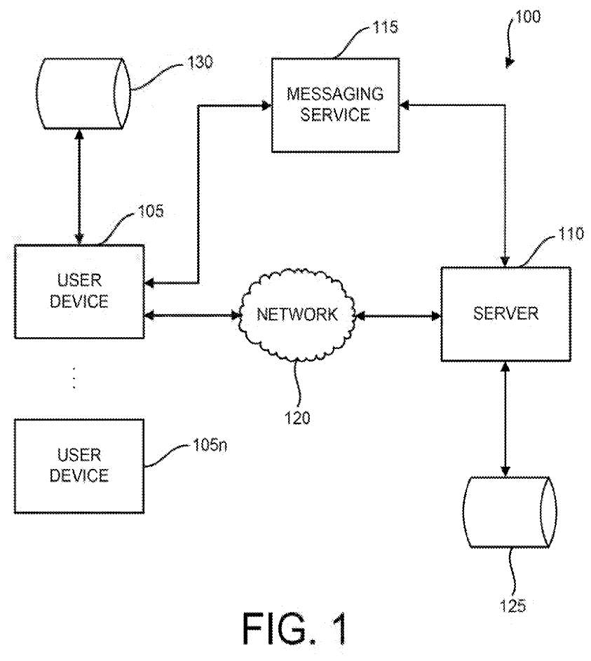

FIG. 1 is a high-level diagram of a system 100 that allows a user of a limited capacity computing device and/or a computing device using a low data capacity communication channel to request and receive complex data analysis and graphical representations of data. One or more user devices 105-105n can each send and receive messages to a remote server 110. The client device 105 can be a conventional user computing device such as a cell phone, smart device, tablet computer, PC, or other device having a processor, a memory for storing application software and data, a display, a user interface for data entry, and a wired and/or wireless data connection through which data messages can be sent to and received from the server 110. The user device may have access to internal data and also data via external data sources 130.

Server 110 is a computer system with one or more processers and memory for storing application software and data. Server can have access to one or more data sources 125, which may be one or a combination of data storage located within or directly connected to the server 110, data available on a local network, or cloud storage accessible via the Internet.

An analytics request, such as a request for a set of data to be displayed in a graph or chart, with certain embedded commands, is prepared and sent from a user device 105 to the server 110. The request is evaluated by the server and an appropriate response generated by the server and then returned to the user, such as in the form of numeric text or a chart or graph image data. System 100 allows a user to quickly and easily perform data analysis and generate graphs and charts without requiring complicated application software to reside on the user's device.

In an embodiment, the server is configured to operate on requests in the form of a single purpose syntactically complete message, referred to herein as an atomic container. The server interprets the contents of an atomic container to determine the type of action desired. More complex expanded workflows from which an atomic container can be generated can also be processed by the server. The atomic containers, expanded workflows, and other data can be stored by the server in an archive. The archive can be later accessed for audit, reproduction, and modification of user requests, by the same or different users.

Returning to FIG. 1, communication between a user device 105 and the server 110 can be via a network 120, which can be a broad band data network available via cellular, WiFi, or Bluetooth wireless internet connections, wired network connections, or other means. Different user devices can communicate with the server 110 over different types of communication systems. Likewise, server 110 can be configured to receive communication from user devices via multiple links and may communicate with different user devices 105, 105n using different data systems.

In a particular embodiment communication from a user device 105 to the server 110 can be via SMS or other text or data messaging system 115, such as provided in GSM and later communication standards and which may be limited to individual messages of 160 text characters in length. The server 110 is assigned a text address to which texts can be sent. Alternative messaging services include instant messaging (IM) and multimedia messaging (MMS). Return communication from server 110 to a user device 105 may also be via the same messaging system as being used by a given user device although other channels of communication may also be used, in addition to or as an alternative. For example, the server including e-mail.

The minimal format used for the atomic container allows a complete atomic container to be entered by a user in a relatively small number of text characters, such as less than 160 in an example addressed below, and which can then be easily transmitted using a text messaging application. This allows the present system 100 to be meaningfully used via texting when a user device is in a limited cellular environment where a robust data connection is not available to the user, such as a remote or sparsely populated area with minimal cellular service. The user can manually type the content of the atomic container into a texting interface or can make use of front-end application software that can simplify user interaction and ensure proper format of the text message subsequently sent.

While a complete atomic container can be carried within a single text message, text messages that are entered and exceed the maximum number of characters for a single message are usually automatically broken into multiple messages by the user device's operating system. To account for such a case, server-side software can include functionality to automatically reassemble texts received from the same source if an incoming text indicates the text message has been divided into multiple texts.

The atomic container processing functionality at the server is robust and can reconstruct certain types of information needed for data visualization even if that data is not present within a container. As a result, this information can be deliberately omitted from the container sent by the user, thereby increasing the amount of other information that can be sent in a limited capacity data communication, such as a single text message.

For example, and as discussed further herein, a user may want to obtain a graph of values in a table of data with C columns and R rows. An atomic container can texted to the server that includes a data sequence of C×R numeric and alphanumeric values but that deliberately does not specify the table geometry (freeing that space for additional data). As discussed further herein, for many table configurations the server can reconstruct the appropriate table geometry, e.g. C columns and R rows, by use of analytical techniques and/or a trained artificial intelligence system. Likewise, while the desired display type, such as a chart or graph, can be specified by the user but may also be omitted. In such a case the server can autonomously determine which display format is most likely correct based on factors that include, e.g., content of the data, similarity to prior datasets with known display types, and prior requests by the particular user.

Unlike complicated workflows that may be captured while using conventional data analysis and display systems, such as a spreadsheet software, the single purpose atomic container format used in the present system provides a ‘clean’ workflow data set that can be processed directly by the server and used as atomic elements in other applications. Given an atomic container with a single purpose request for display of a given set of data in a specified format, the same or other user can refer to that container and provide replacement data without having to specify other attributes of the table.

According to another aspect, given an archive of atomic containers each with a single purpose clean request, the collection of atomic containers can be easily parsed to identify those directed to a desired function, such as graphing or charting a set of x/y data. This data set can then be used directly, or with only minor processing, to train an AI system for use in reconstruction of incomplete requests in an atomic container, such as a request to graph table data but which request omits the table geometry or the visualization type. As new atomic containers are received by the server, they can be added to the training dataset to allow AI supported request reconstruction to be continually improved over time.

An atomic container will generally include some data values and all of the information that the server needs in order to determine what analytics and display type the user wants performed on the data and returned to the user. The total extent of required data may depend on the server functionality. For example, if the server is configured to select a visualization type for certain requests if it is not specified in the request, the visualization type could be included but would not be required for an atomic container with such a request. Likewise, if table data is provided and is such that table geometry can be reconstructed, table geometry is not required to be included in the request. Because the request is complete, the server can operate in a stateless implementation where a request is received from a user device, processed, and the generated output returned to that user in a single set of operations. The syntax, format, and various options for a container according to an embodiment follow.

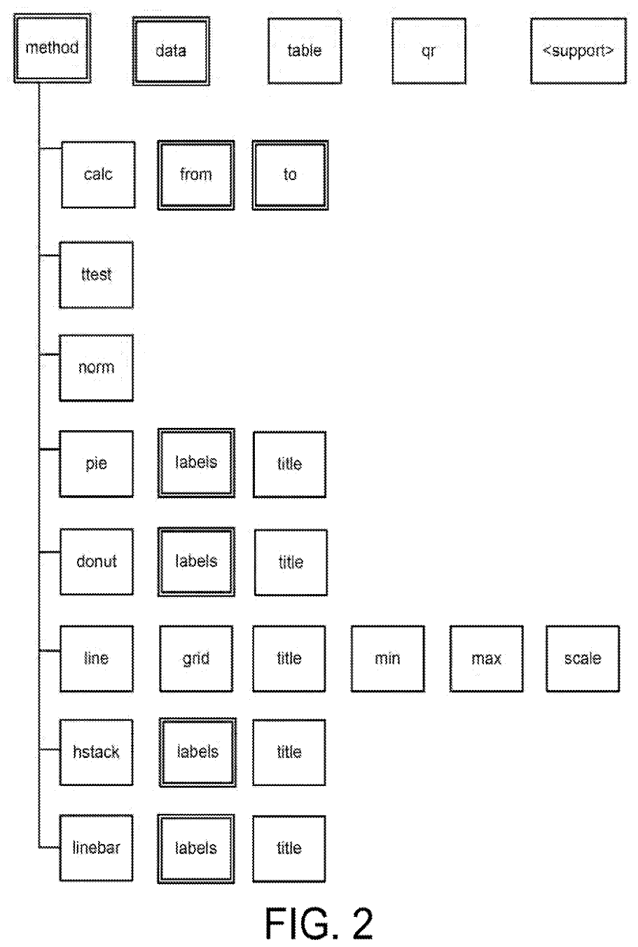

The features and options of an atomic container can be structured as a nested semantic tree. Such a structure is easily scalable by addition of new features and options to the tree. FIG. 2 is a representative example of a nested semantic tree 200 with a variety of different of features and options of the service. Features and parameters indicated by double lines are generally required to be present for an atomic container to be successfully processed by the server. As discussed, and addressed further herein, in certain cases these required elements can be omitted by the user in which case the server 110 will attempt to reconstruct the full request which can then be processed. If reconstruction is successful, the received atomic container on the server side can be updated to include the reconstructed fields. The original container, reconstructed container, or both can be stored by the server 110 for later reference.

The method keyword is used to signal a designation of the type of analysis to be performed and includes as an argument the type of analysis to be performed. Various types of analyses can be performed. Graphical data representations can be performed in specified formats such as representation in a line chart (“line”), line and bar chart (“linebar”), a horizontal stack chart (“hstack”) a pie chart (“pie”), and a donut chart (“donut”). Other non-graphical data analyses can also be designated, such as a calculation request (“calc”) to perform common functions, and statistical functions such as a t-test of data means (“ttest”) and non-normality (“norm”)

For these and other keywords, the keyword text has been selected to simplify readability and manual entry by user. To further make use of a limited size data message, such a single text message, these keywords can be shortened to as much as one, two, or three characters at the expense of use friendliness. As an example, “met” instead of method, “l” for line chart, “lb” for line and bar chart, etc. Depending on the number of keywords it may be possible to assign a single character for each key word. This would increase the difficulty of manual data entry, e.g., by typing into text message interface, since meaning would not be immediately clear but this issue is of less significance if a data entry and formatting front end is provided on the user device. Likewise, conventional formats can be used to indicate arguments for keywords, such as parenthetical offsets (method(x)), periods (method.x), etc.

In addition to specifying a desired method, the data to be operated on also needs to be provided. For requests to generate a table display, the data can be provided as a delimited list of numeric and alphanumeric values supplied as arguments to a table keyword (“table”). Table data is presented in a predefined ordered sequence, such as relative to row and column indices. By example, the data can be presented sequentially for each row in column order or presented for each column in row order. Each value is separated by defined delimiter such as a space, line break or symbol such as a comma. Alphanumeric entries can be further defined by one or a pair of start and stop delimeters, such as a start and end slash “/” with alphanumeric data in between or a start designator, such as a “/” with alphanumeric text following until the value delimiter is reached.

As noted, the table geometry does not need to be specified for certain classes of partial or fully numeric tables for which the geometry can be reconstructed by the server. Such classes include tables with a header row or column of alphanumeric data that label what the numbers in that column or row represent. If column data itself constitutes labels that is indicated by a designated label keyword, such as “labels” as the column header value.

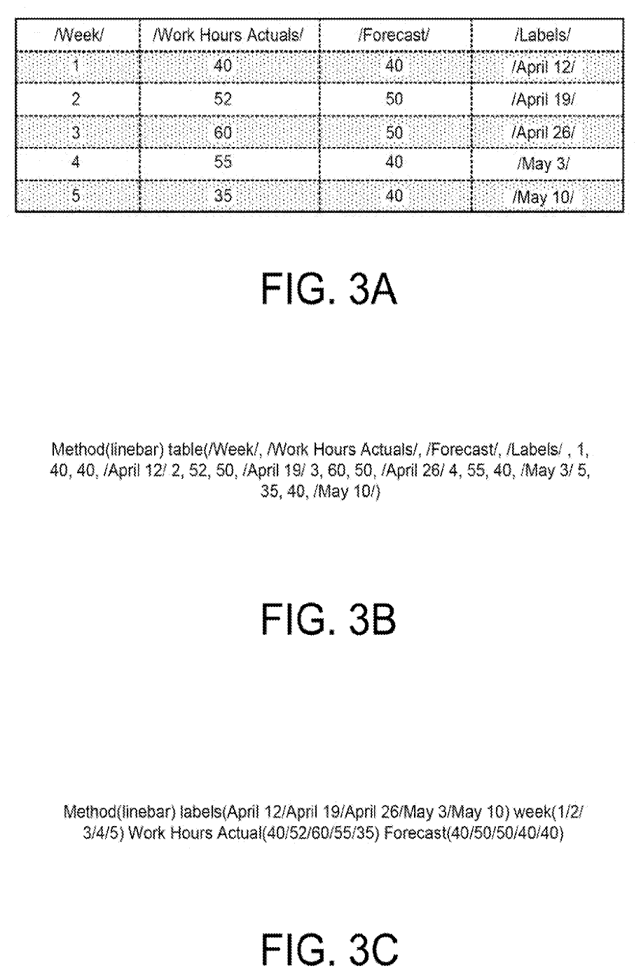

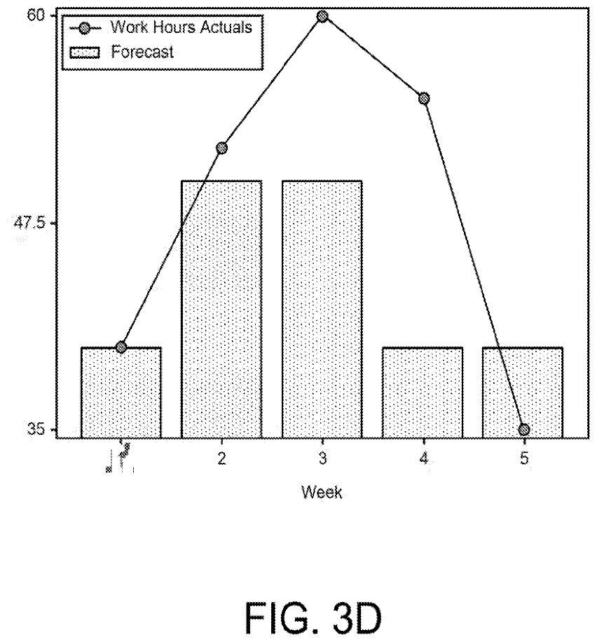

FIG. 3a is an example source table of data that is structured in 4 columns and 6 rows and that includes a column of data labels. The table may be data presented from external software systems, such as a spreadsheet or word processing application, or can represent data from other sources, including printed text. FIG. 3b is an atomic container text representation of the source table of FIG. 3a according to the protocol described herein and representing a user request to prepare a line-bar chart representation of the table data. The data in FIG. 3b can be entered in various ways, including manually typing the data, or by cutting-and-pasting the table data text from a source application, such as a spreadsheet or word processor. In the example, comma delimiters are shown. Alternatively, a delimiter such as this can be omitted and the data values simply separated by spaces. The geometry of the original source data table does not need to be specified; rather it will be reconstructed by the server. In a variation of the protocol, if an atomic container includes a table designator followed by table data or a data sequence and other indication that it is table data, but omits a method specification, the server can examine the table data and determine a best or most likely type of representation and select that for use. If the server process is implemented as a stateful process (as opposed to stateless), the server can alternatively send a query to the user, such as a reply text message, asking them to specify the method type. Such a message to the user can include one or more options which may be identified by the server as the most likely options based on, e.g., on analysis of the table data contents.

Returning to the semantic tree of FIG. 2, data can be alternatively represented in a longer form in which the labels are separately identified, e.g., as arguments to the label keyword. Likewise, the data can be represented in one or more data groups as needed for analysis, with the first data group typically assigned for the x-axis (in a graph application) with the order of the remaining groups unfixed. FIG. 3c is an atomic container representation of the source table of FIG. 3a according to this alternative where the table data is provisioned as explicitly organized data groups. FIG. 3d is a sample of a graphic visualization of a chart that can be returned by server 110 in response to receiving an atomic container as set forth in FIG. 3b or 3c.

An atomic container with a request to produce a chart can also include other optional features. A title can be specified (keyword “title”) and presentation details can be specified if desired such as, for a line chart, and options that may include whether to show a grid, the chart scale, and the min and max values to show on the x and/or y axes.

Various other methods and keywords can be supported as well. With further reference to FIG. 2, each container that is processed by the server can be archived and stored with a unique identifier. A keyword in the container can be used to specify that the server return the identifier assigned to the container or this can be done by default. The identifier can be returned as a numeric or alphanumeric ID, a link, such as a URL, or other manner which can be saved or passed to a third party who can use it to replicate some or all of the request by the same user of a different user at another time. The identifier or link can be returned in text or in graphical form, such as a 1D or 2D bar code. In an embodiment, the keyword qr signals the server to return a QR code which can be scanned to recover the URL data. Other options are also possible. For example, a QR code could be returned with the content of the container that includes the QR request wherein the QR code could be scanned to easily reenter the container to reproduce and/or modify the request.

The atomic container, the generated image and/or other responsive data or links thereto, as well as additional metadata can be stored in a combined atomic analysis unit (AAU) data record that can be stored in storage 125. The AAU data can be referenced during and after the processing of its associated atomic container. The single-purpose clean nature of the atomic container also allows the AAU records to be easily used as a source of data for other activities, such as computational analysis or AI training to help in reconstruction of requests with missing data.

In an embodiment a request received from a user device and that includes a reference to a prior atomic container can be interpreted by the server 110 as a request to create an atomic container that has the content of the prior referenced one container with portions of that earlier container replaced by content in the currently received request. The modified atomic container can then be processed by the server as if it were received in that modified form, and so assigned its own ID, saved, processed, and the appropriate result returned to the user. The request itself can be an atomic container or a more.

By way of example, if the atomic container as shown in FIG. 3b were assigned an ID of 12345, a user could request the same data be processed and shown in a different form by sending “cn(12345) method(line)”, wherein cn is a keyword indicating a reference to another container. On receipt, the server would generate a modified atomic container based on container 12345 (FIG. 3b) but substitute “method(line)” for the original “method(linebar)” content. The modified atomic container generated in this process could then be stored with its own ID and processed to return a chart with the original data but in a line instead of line-bar format. Similarly, if the atomic container as shown in FIG. 3c were assigned an ID of 23456, a user could send “cn(23456) work hours actual(50/42/40/50/35)”. The server would then generate a modified atomic container that corresponds to the original but where ‘work hours actual’ data is replaced with the new data. That modified container would then be processed. This method increases overall system performance and simplifies collaboration by allowing reuse of any previous container without having to reenter it and where the server will automatically modify the previous container to add or replace the relevant portions with substituted data. This functionality also improves overall usability and network efficiency since it reduces the amount of data that must be entered and sent by a user device in cases where a user wants to, e.g., change the display type of a given visualization or recreate a prior visualization using new data but in the prior format.

Additional keyword functions can also be implemented within the server 110. For example, keyword driven user support can be provided through text and media instructions to the user. A user can text a message requesting help, such as a message with a help or support keyword and the server can return instructions as appropriate. (While a client-side app is not required to access the server side features, user support could be implemented in a client-side app as well or alternatively.) Similarly, if the system is subscription based or user IDs are otherwise tracked, a query can be sent that will initiate return from the server of subscription related information.

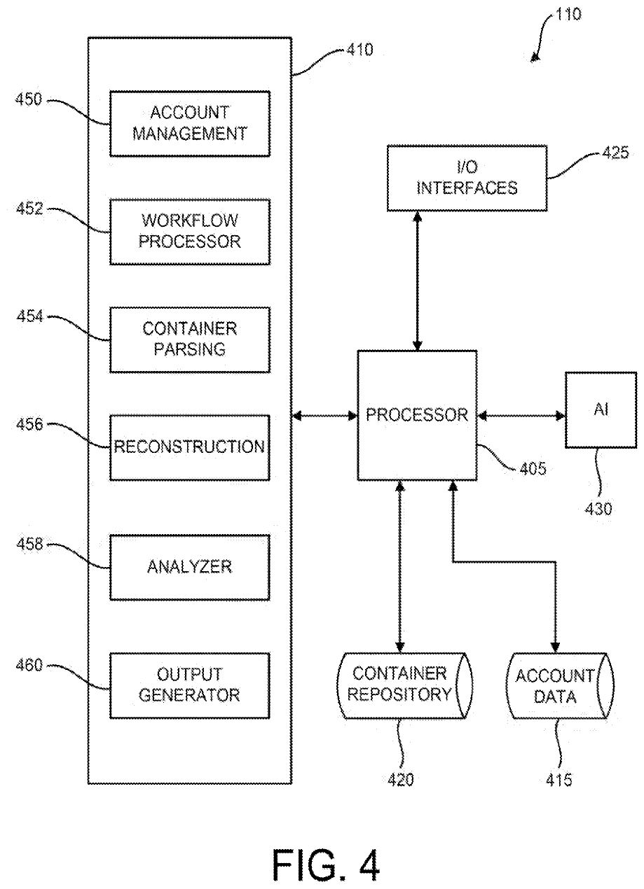

FIG. 4 is a high-level block diagram of relevant components in a server system 110. The server comprises a processor 405 (which may be one or multiple processors) that can execute computer instructions stored in a program memory 410 and that can retrieve, store, and operate on data in one or more data stores, such as for storing user account data 415 and maintaining a container archive 420. I/O interfaces 425 allow the server to communicate with remote client devices and other mechanisms through supported data communication systems, which can include cellular messaging services and internet-based communications (which themselves may be accessed over a cellular link). The program and data storage 410, 415 and the container archive 420 can be maintained in one or more of on-board RAM, carried in local media such as magnetic or optical data, stored local data storage devices accessible over a LAN, or in cloud storage. While the program and data storage 410, 415 and the container archive 420 are shown as separate elements they can be combined or divided into one or a plurality of physical devices.

The server 110 can also include an AI system 430 that includes a trained AI model and can also include functionality to initially train and/or update the training of the AI model. The AI system 430 could be implemented within the server 110 or as a separate system that can be local to the server 110 or remotely accessed, such as a cloud-based AI service.

Program memory 410 includes a number of separate application engines. Account management 450 is used in implementations where access to the system 100 needs to be approved. The Account management engine 450 can utilize information in account data storage 415 to determine a user ID associated with an incoming communication. External data can also be used during an ID verification process. For example, a reverse number look-up of the phone number of an incoming texted container can be used.

As discussed further herein, instead of sending an atomic container, a user can instead send a workflow object that can include a variety of information beyond that which would be included in an atomic container and/or that does not comply with the atomic container protocol. Workflow Processor 452 receives an incoming workflow object and processes the contents of the workflow object to generate an atomic container that adheres to the container protocol and which can be further processed in the same manner as if the generated workflow container were received directly, e.g., via text message, from a user. If multiple separate analysis requests are contained within a workflow, the workflow processer may operate to generate a plurality of atomic containers, each of which may then be processed in turn.

The Container Parsing engine 454 extracts the selected features and options, which indicate the intention of the atomic container. Numeric and alphanumeric data is also extracted. The reconstruction engine 456 operates on table related requests to reconstruct the table geometry and thereby the source data format as may be needed using the numeric and alphanumeric content proved from the Container Parsing engine 454. In one embodiment the reconstruction engine 456 uses analytical techniques. In another embodiment, which is useful when analytical techniques may be inconclusive, the reconstruction engine 456 can also utilize the services of the AI system 430. The reconstruction engine 456 can also operate to fill in missing but required components of a complete container, such as a type of table display that best fits provided table data.

Analyzer engine 458 performs the actual analysis on the data and generates text and image results. The output generator 460 formats the results as appropriate for return to the sending user's device 105 using the appropriate I/O interface 425. The results of the analysis can also be saved in account data storage 415.

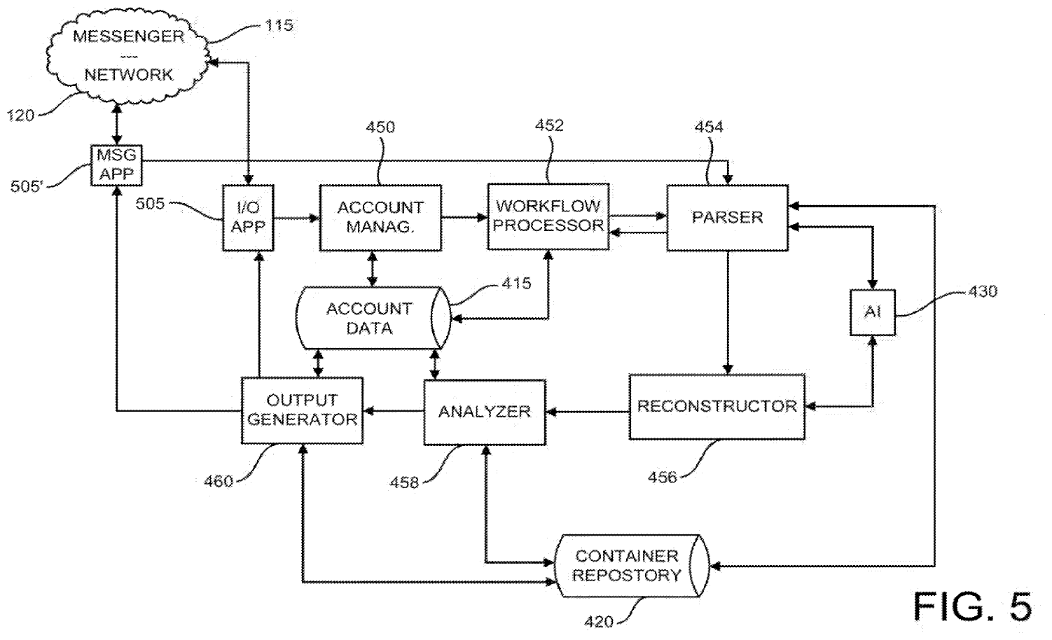

FIG. 5 is a high-level flow diagram showing functional data flow of operation of the server 110 in response to a relevant communication from a user device 105. The communication can be in the form of an atomic container, an atomic container that references one or more existing containers, or a more expanded workflow from which a container can be derived and which message may reference other containers and/or contain additional workflow and user information. One example of this is a structured text-based object workflow message, which can be for example in the form of a JSON, XML, or http format as discussed below.

A message is initially received, such as over a messaging link 115 or other data communication system. Input processing is handled by an appropriate I/O interface app 505. Separate apps may be used for different interface types. For example, I/O App 505 can be provided for communication over an internet link, and may comprise one or more internet messaging applications. These types of communication channels generally have robust bandwidth capabilities and it is anticipated that messages will expanded workflows without any requirement for an initial input message to be a compliant atomic container. A separate messaging application 505′ can be provided for communication via other channels, such as a cellular SMS text messaging interface, and where bandwidth limitations may make it impractical for expanded workflows to be sent and where text based atomic workflows are expected (and may be a required input format).

If the system 100 is subscription based or an implementation for which user ID information is otherwise used, the account management engine 450 is used to evaluate user ID and access related information. In FIG. 5, messages received via I/O App 505 are processed by the account management engine 450, while messages received via Messaging App 505′ are not. The incoming message input to the account management engine 450 may include data specifying a unique user ID or a unique device ID. Unique user ID is useful if the same user desires to access the system from multiple different devices. In the case of a received SMS text request (for an implementation where account management is performed for such messages), the message will identify the sending user's phone number of other text message ID. Account data repository 415 can be accessed to determine if an account already exists for that ID and validate the user as appropriate.

User account information can include data such as telephone number(s) for a given user, user preferences, subscription type, and other information including a record of prior requests and responses by that user. If a user account is not found, the account management engine 450 can search various internal and external data sources, such as reference dictionaries, lists, keywords, reverse phone number look up databases, etc. that can be used to identify a user associated with the source of a received message to allow the user to be validated. If it is determined the communication is from a new user, a new user ID record could automatically be created or this can be done as part of a subscription sign-up process (not shown). The account management engine 450 can also initiate a subscription process, requesting appropriate information from the user, e.g., in a text message exchange.

As should be appreciated, account management may be minimal or entirely omitted. In an embodiment without any account management, such as if processing of containers is implemented as a stateless system, the system can still keep track of any unique ID included with a communication, such as a phone number or device ID, and use that ID to maintain an archive of communications from that phone number/device ID.

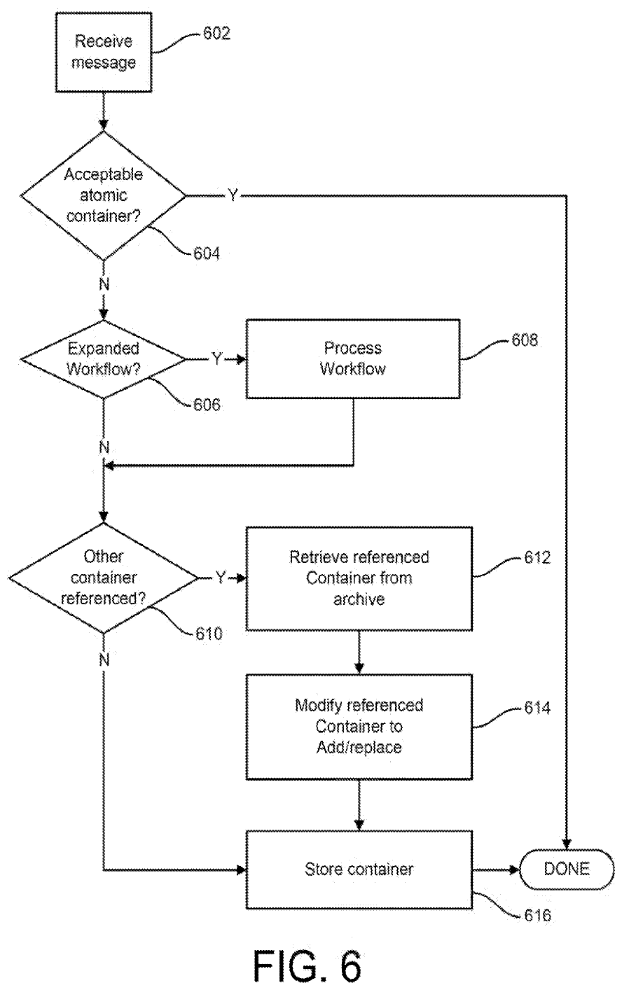

With reference to the flow chart of FIG. 6, an initial message is received by the workflow processor 452 (step 602). An initial check is done to determine if the message is an atomic container that is in compliance with the message protocol, such as of FIG. 2. An example of such a message is that shown in FIGS. 3b and 3c. (Step 604). If the message is an atomic container suitable for downstream processing by the parser 454 no initial modifications may be needed necessary and the message can be passed for further processing as is. Otherwise, further processing can be performed to process the content of the incoming message to modify or otherwise generate an appropriate container that is protocol compliant.

If the message is an expanded workflow (step 606), from which an atomic container can be generated, that workflow is processed to generate a text string according to the message (step 608) and the process continues according to step 610. If it is not an expanded workflow, step 608 is skipped. The text is then examined to identify any keywords and associated text that indicate a reference to a prior atomic container stored in the archive. (Step 610). If a prior container is referenced, the referenced container can be retrieved from the archive (step 612) and the retrieved container modified and/or supplemented according to other content in the current text. The modified/supplemented atomic container can then be used as if this container was received as the input from the user device.

The output of the workflow processor 452 is an atomic container which can be assigned a unique ID and stored in the container repository 420 (step 616). Other data, such as any precursor messages, can also be stored and linked to the same ID. It should be noted that the steps in FIG. 6 can be performed in a variety of different orders. For example, a check for an expanded workflow (step 606) can be done prior to determination of whether there is an acceptable container (step 604).

The text output from the workflow processor 452 is then input to the container parsing engine 454. If the system 100 is configured to assume input messages should already be in the atomic container format, the full functionality of workflow processor 452 is not needed. In implementations where an atomic container is permitted to reference an earlier atomic container as a base container to be modified, the look-up and modification process (FIG. 6, steps 610-616) could be implemented in the parsing engine 454. Alternatively, if a prior container reference is detected by the parsing engine 454, the parsing engine 454 can issue a request to the workflow process 452 to retrieve and modify the referenced container as appropriate and then return the modified atomic container to the parsing engine 454, which could then continue processing or treat the modified atomic container as a new input. If a referenced container itself contains a reference to an earlier container, the process may repeat until all external container references are addressed. This nested container-reference situation can be avoided by storing as the ‘official’ version of an atomic container with a container reference the fully instantiated modified container. The initial input that includes the cross reference can also be stored in the atomic analysis unit linked to the container ID.

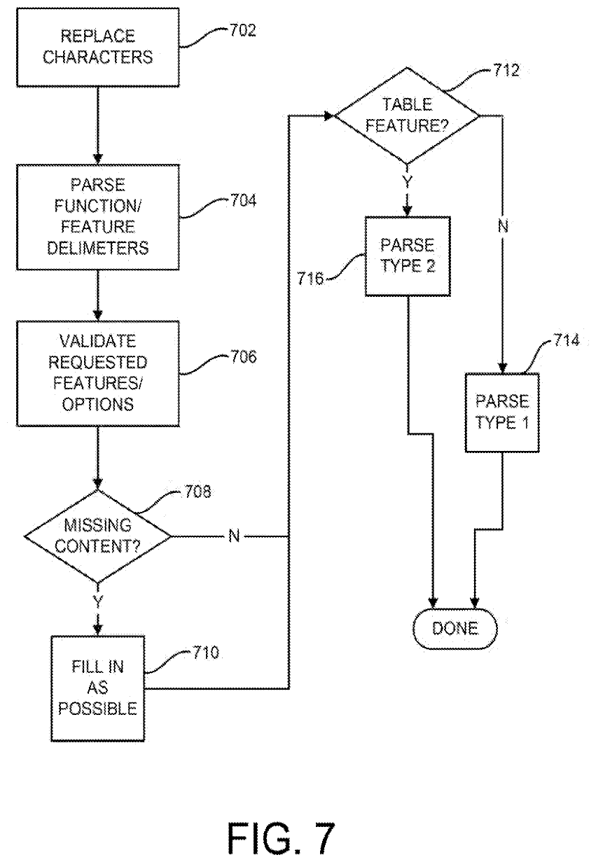

Returning to FIG. 5, parsing engine 454 processes received text message to provide a clean text stream that can be passed to the table reconstructor. The parsing engine 454 can perform operations such as stripping out metadata, removing or replacing non-standard characters, etc. With reference to the flowchart of FIG. 7, implicit special characters in the request body text, such as breaks, tabs, non-breaking spaces, can be replaced with an explicit whitespace for consistency. (Step 702). The body text is parsed using the explicit function/feature delimiters such as open and closed parenthesis ‘(’ and ‘)’ to create a set of parsed substrings. (Step 704).

The requested analysis features and options identified in the parsed substrings are verified against a framework reference list. (Step 706). Additional syntax and completeness checking can also be performed at this stage or earlier or later in the process to identify situations where required elements are missing. (Step 708). If content is missing, certain missing elements may be able to be filled by the system (step 710). Advantageously, by including this functionality within the server 110, the system's user-fault tolerance is increased, reducing the number of incidences where a request from a user cannot be serviced and where a user would then be given an error message and need to manually correct and resend the request. Communication bandwidth efficiency is also increased since a user could opt to rely on the functionality and so omit such required content from the communication to the server thereby freeing up limited bandwidth, such as number of characters in a text message, for use with other content, such as more data values.

Data groups in the message are then parsed so that each data group and data group member can be identified. In an embodiment, data parsing may vary if data is present for a table feature or data is associated with a different feature, such as a calculation. If a table feature is not provided (step 712), data groups in the body text can be parsed using an explicit delimiter, such as a forward slash ‘/’ delimeter. (Step 714). If a table feature is provided, the related substring can be parsed using the explicit whitespace and forward slash ‘/’ delimiters into an additional list of substrings. (Step 716).

Returning to step 710, there are ways to supply values for missing content. For some elements, default or user preferences can be referenced. As an example, if container includes non-table data but does not indicate a particular display method, the system may default to displaying a pie chart and if table data to a line chart.

A more sophisticated approach can also be used. In one embodiment, when table data is provided but a display method is not specified, the system can analyze the received data itself and compare it to data in other atomic containers that are archived in the container repository 420 and which have been successfully processed and for which the display method was specified. Statistical data analytic techniques known to those of ordinary skill in the art can be employed for these purposes. A determination can then be made as to which display method is the most likely given the display methods used by similar data sets. The analysis can be limited, such as to containers from a single or designated group of users, or the entire container archive could be search to identify similar data sets and from which the most likely display method can be selected. Such an analysis can be performed in advance and one or more data signatures generated and which are associated with respective display methods.

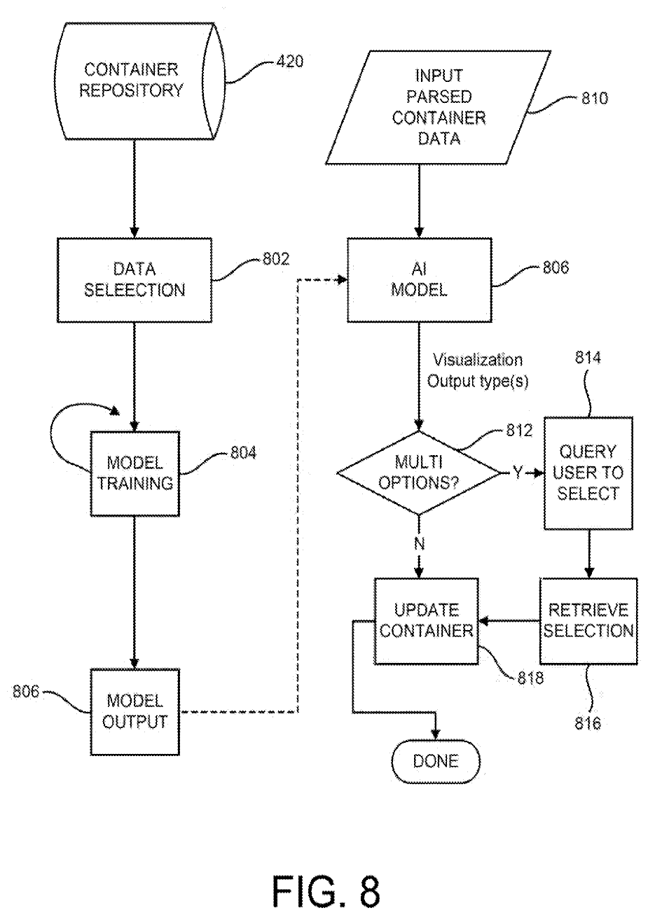

Instead of an analytical approach, in an embodiment and with reference to FIG. 8, a trained AI system 430, such as a deep-learning AI system, can be used to evaluate parsed container data to determine the most likely visualization output type (or other missing value). The single-function and minimal format nature of an atomic container allows the container repository 420 to be easily and efficiently mined to generate an AI dataset of complete and validated containers meeting specified criteria, such as requesting a table. (Step 802). AI training techniques known to those of ordinary skill in the art can then be used to train the AI system to predict an option, such as table display type, based on actual display types requested for many different data sets. (Step 804). Once the trained model is available, it can be incorporated into an AI system 430 that can be utilized during container processing. (Step 806).

When a missing element for which the AI system has been trained to predict is detected, such as by the parsing engine 454, the AI system can be utilized to predict the most likely value. For the table visualization option type example, the relevant table data on which the AI system was trained and which is available, such as the table data content and labels, is input to the AI model which then outputs probabilities for the different display types that could be selected. (Step 806).

The AI output value with the highest probably can be selected as the option. If multiple options are available (step 812), such as where the top n options fall within a designated probability spread so none is clearly a best selection, a message can be sent to the user requiring selection of a display option type. (step 814). The message can include options from which a section can be made. These could be limited to the most likely options, such as the top n, or all possible options could be presented. The options for selection could be sorted in order of highest to lowest probability as determined by the AI system. Typically such interactive communications will be made using the same connection methodology as the initial communication from the user.

After automatic selection based on the AI outputs or on receipt of a selection from the user (step 816), the selected option can be used to update the container (step 818). The modified container can then be stored in the container repository 420. Alternatively, or in in addition, the initial pre-modified container is stored in repository 420 as well.

Where the user has specifically selected a table format from a set of presented options or has validated a selection made by the AI system, the resulting AI completed container can be used to adjust the training of the AI model, either in a discrete training run or by adding it to the data set for use in a subsequent training cycle. As new containers are input by users, they too can be added to the training dataset to allow AI supported request reconstruction to be continually improved over time.

While table display type is used as example, it should be appreciated that the AI system can be trained using containers extracted from the container repository 420 to identify likely values of other elements that are missing from but needed for a container workflow to be properly executed based on historic data.

Different techniques can be used to reconstruct different types of data. A particularly significant bandwidth savings can be made by reducing the need to provide complete dates for date based data, such as numeric data organized by day, week, or month during a span of time. Conventionally, each such unit of x/y data would be represented as a date and the associated data value. Each date value would require a number of characters.

For example, a year's worth of data values with each having a date value in the form YYYYYMMDD (year, month, day) and a delimiter, could require 10*365=4014 characters. To significantly reduce the data volume, the system can be configured so that only one, two, or a few date values need to be provided in the input data and the remaining calendar dates are reconstructed at the server. If only a single date is present, the system can assume that each data entry is for the next day and so only a single date is provided. If a start and end date is specified, the dates for each entry can be determined by assuming equal period between each data value and determining the dates accordingly. A date plus date interval could alternatively be specified, e.g., a start date and then an interval of 1 day, a week, a month, etc. and this used to calculate dates for all the data values. By this approach, providing a years worth of data and specifying only the start data reduces the number of text characters to specify the date for each data point from 4014 to 10.

It should be appreciated that while efforts to fill such missing data are discussed herein as part of the operation of parsing engine 454 this could instead be implemented in a separate engine or within the reconstruction engine 465, addressed below.

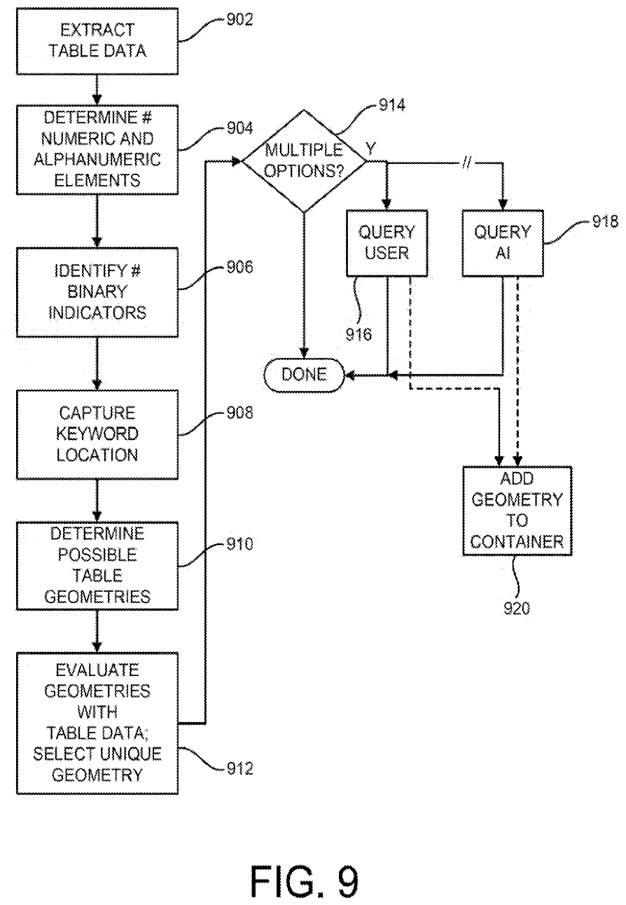

After parsing the container text, if the method involves display of a table the table geometry may need to be reconstructed. Turning to FIG. 9 and with further reference to FIG. 5a, a method of reconstructing table geometry is presented. An initial input is the content of the data tied to the table keyword is extracted (if not already done as part of the parsing process). (Step 902). For the example of FIG. 3b, the table data is “(/Week/, /Work Hours Actuals/, /Forecast/, /Labels/, 1, 40, 40, /April 12/2, 52, 50, /April 19/3, 60, 50, /April 26/4, 55, 40, /May 3/5, 35, 40, /May 10/”).

Next, the number count of numeric (N) and alphanumeric (T) elements of the list is obtained by parsing the request body text and removing non-alphanumeric content. (Step 904). If one or multiple binary indicator variables (L) are included, e.g., in relation to the presence of additional label columns, they are also counted, where each binary indicator is given a value of 1 if labels are present in the text and otherwise it is zero. (Step 906). Label columns can refer to labels at individual rows (L0), or labels at groups of rows (L1, L2, etc.) (The presence of a binary indicator can also be used as a signal of the presence of a table feature (step 712) and so can be used to determine whether to perform a type 1 parsing with if there is no binary indicator (step 714) or a type 2 parsing if there is a binary indicator (step 716).)

An example of multiple binary indicator variables, the user may submit a table with multiple sub-tables of column dimension c and row dimension r inclusive of a binary indicator variable L0 for data labels. The sub-tables are identified by additional binary indicator variables L1 to Lk. For example, sub-table factors such as city, associated with a keyword ‘city’, or state, associated with a keyword ‘state’, or country, associated with a keyword ‘country’. The number of indicator variables is countable through the keywords provided in the body of text. In the example above with labels and 3 factors, the count of keywords ‘label’, ‘city’, ‘state’, ‘country’ provide the value of L=4 needed for the quadratic equation.

In the next step possible table geometries are determined (step 910). There are various approaches that be used. Once possible geometries have been identified, they are evaluated with the actual table data to find a unique geometry that is a best fit based on the provided table data. (Step 912).

In an analytical technique, assuming a table having C columns and R rows, the total number of data elements in the table C×R, the expected values of T and N can be determined as T=C+(R−1)L and N=(C−L)(R−1), where T+N=R×C is the total number of table elements. This assumes that the table includes a header row.

The possible values of C and R can then be determined. For example, in this table type the value of C=0.5*(T+L)+/−0.5*sqrt [(T+L)²−4(T+N)L].

Once the unique value for C and thus for R is determined, the column and row dimensions (c,r) of the sub-tables can then be determined from C=c+L−L0 and R=1+(r−1)M(L1,L2, . . . , Lk) where M(L1,L2, . . . , Lk) is the number of unique combinations of the indicator variable L1 to Lk with a boundary condition of M(0)=1 when L1 to Lk are not present.

After c and r are determined, the table can be parsed into sub-tables for combinations of, e.g., city, state and country. (These sub-tables can be plotted as sub-plots by the analyzer and provided to the user for the purposes of comparative data analysis.)

There may be instances where an analytical approach, such as above, does not provide a single table geometry that is consistent with the table data (Step 914). This can be addressed in a manner similar to that for determination of the type of table display as discussed above with reference to FIG. 8. In one embodiment, a query can be sent to the user presenting the various table geometry options and asking for a selection in response. (Step 916). In another embodiment, the contents of the present table data can be compared to data in atomic containers in the container repository 420 that request tables of known geometry (either reconstructed or specified by the user) in order to identify tables with similar sets of data according to a measure of correlation and the table geometry of the closest match selected.

In a further embodiment, a trained AI system 430 can be used to process characteristics of the current data to determine a most probable table geometry. Such an AI can be trained using a dataset of atomic containers from the container repository 420 which request a table display and for which the table geometry was specified by the user or successfully determined by reconstruction. If multiple options are available, the user can be queried as above.

Continuing the example based on FIG. 3b, there are 15 numeric elements (N=15) and 9 alphanumeric elements (T=9). There is one indicator variable for Labels (L=1). As a result, the potential geometries as per above are C=6 or 4, making R=4, or 6. A data walkthrough can be done assuming either option and a determination made as to which is consistent with the actual table data.

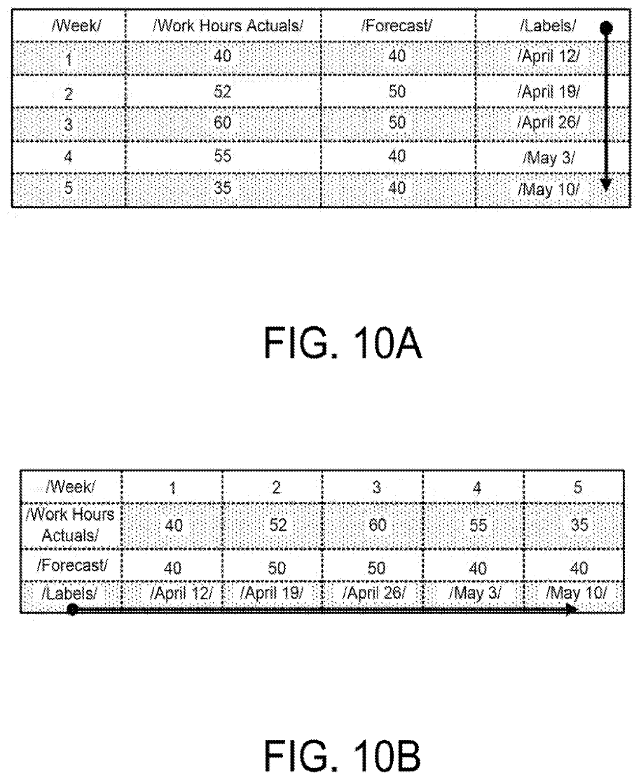

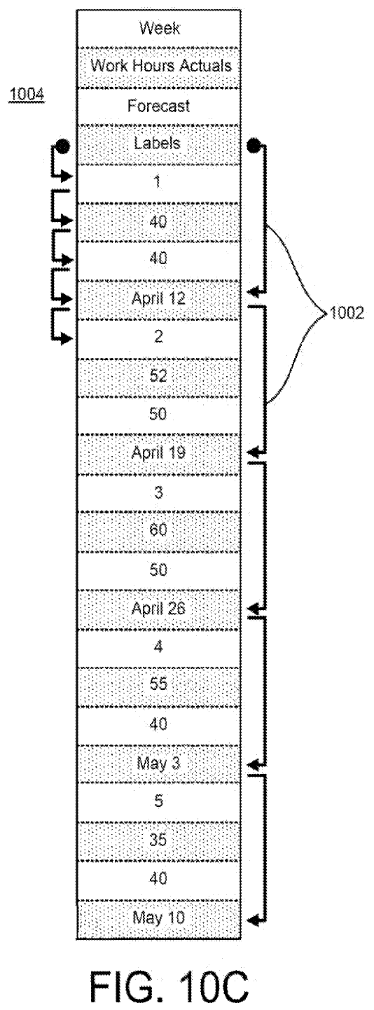

In a first walkthrough, and with reference to FIGS. 10a and 10c, an R×C=6×4 orientation is assumed. Texting of the original table data 10a results in a list as shown in FIG. 10c. To check this table orientation, the location of the keyword ‘label’ is indexed and the process performs a walkthrough of the list. In this example, an orientation match is defined as the detection of R−1=5 alphanumeric labels in the walkthrough. The algorithm is agnostic to the choice of which column was originally used for the labels. Wherever the keyword ‘label’ is detected, the list is searched for additional alphanumerics. This orientation is verified if the labels column walkthrough reveals exactly R−1 alphanumeric labels (5 in the case of the source table of the example).

It should be appreciated that the test table does not actually need to be constructed within the server 110 memory. Instead, the system can advance through the parsed data with a step size of C, in this case 4, such as shown as step 1002 in FIG. 10c.

In a second walkthrough, and with reference to FIGS. 10b and 10c, and R×C=4×6 orientation is assumed. The data walkthrough starts with the label index and progresses incrementally through the next C−1 data entries, as shown at 1004 in FIG. 1c. This orientation is verified if the list row walkthrough reveals exactly C−1 alphanumeric labels (5 in this case).

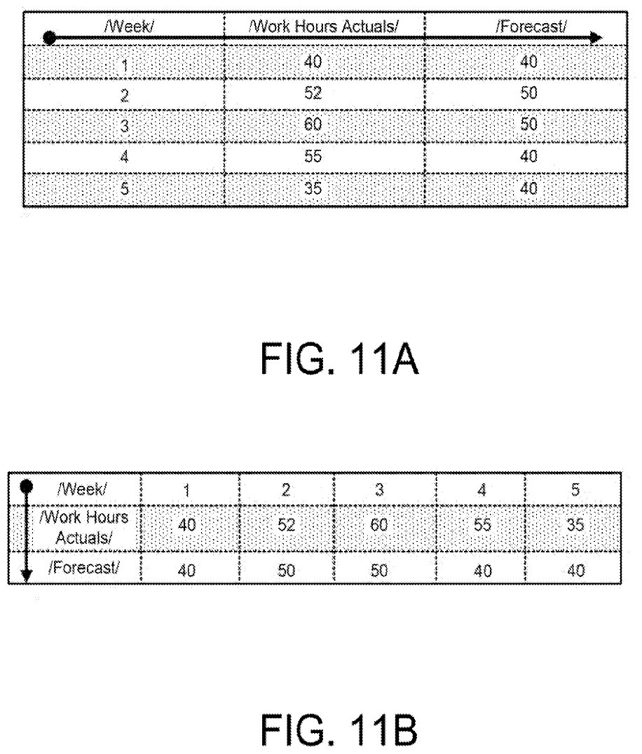

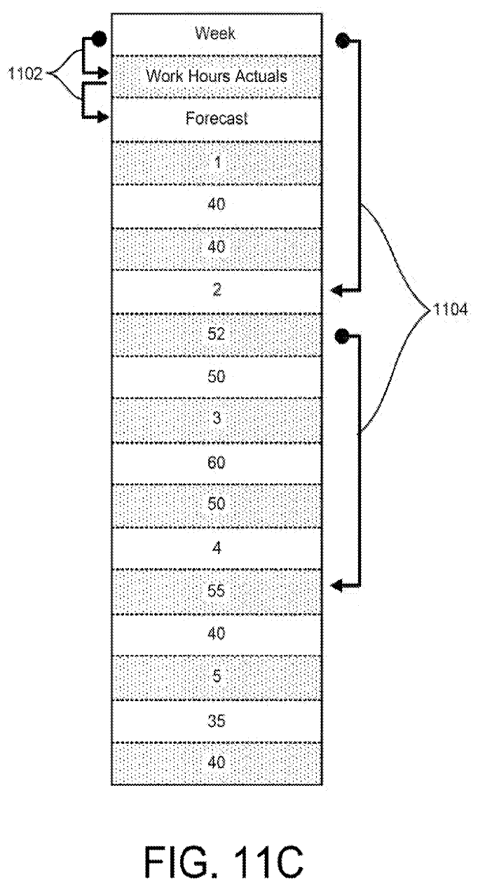

A similar process can be performed to determine unique table orientation when data labels are not included. An example table is that of FIG. 3a but with the last indicator variable column with the labels removed. This results in a source table with 6 rows and 3 columns as shown in FIG. 11a.

During table reconstruction for this example, the value of N=15, T=3, and L=0. The result gives a possible table size of R×C=3×6 or R×C=6×3. walkthroughs similar to above are used to determine which geometry is appropriate.

A third walkthrough type, and with reference to FIGS. 11a and 11c, assumes a vertical table source orientation and no indicator variable column with data labels. It is repeated for each row of the table orientation. The source orientation is verified when a list walkthrough (1102 of FIG. 11c) reveals exactly C alphanumeric data group descriptions (3 in this case). A fourth walkthrough type, and with reference to FIGS. 11b and 11c, assumes a horizontal table source orientation and no labels column. This type walkthrough is repeated for each column of the table orientation. (See 1104 of FIG. 11c) The source orientation is verified if the list walkthrough reveals exactly R alphanumeric data group.

While multiple walkthroughs are shown for each example, once a given walkthrough is successful the system does not need to do any remaining walkthroughs. However, in an embodiment, all walkthroughs could be done so the system can determine if multiple geometries are consistent with the data, on which other remedial action, such as querying the user, can be executed.

In an embodiment the system can assume that the user is only presenting a vertical table layout or only presenting a horizontal table layout and the types of walkthroughs performed selected accordingly.

Returning to FIG. 5A, after table reconstruction or following the parsing (where no reconstruction is needed), the data is passed to the analyzer engine 458. The analyzer performs the requested data processing or analysis of the container based on the parsed features, options and user preferences using the data group arrays, the data group description list, and the data labels list. If user preferences for the requested analysis have not already been retrieved, they can be retrieved from the relevant user account data. Relevant default preferences can also be applied.

For a table, the analyzer 458 will generate the designated graphical representation using the data provided with the designated or determined table type and table geometry and generate a corresponding image. Techniques known to those of ordinary skill in the art for generating line, bar, linebar, stack, and other graphical representations from sets of data known to those of ordinary skill in the art can be used for these purposes. Likewise, when a graphical representation of a linear array of data has been requested, such as a pie or donut chart, conventional techniques for generating a graphical representation of such data can be used. QR code or other 2D or 1D bar code outputs can also be generated using standard techniques.

Other types of requests, such as to convert data values from one standard to another (e.g., Fahrenheit to Celsius) or perform statistical analysis are processed accordingly and may result in the generation of a text output instead of a graphical output.

Graphical data can be stored in a variety of different formats. In one embodiment, the data representations are stored in a vector format, such as an SVG or EPS file. Vector format files are infinitely scalable and, depending on the complexity of the graph, may be smaller in size than a corresponding raster graphic file, such as a JPG, GIF, or PNG file. Output images can be stored with a unique ID. The ID or a URL linking to the image can be include with or provided instead of the actual output.

Output generator 460 takes the results from analyzer 458 and issues a response to the user device 105 associated with the request that has been processed. In an embodiment, one aspect of the output generator 460 operates to generate a specific response message that is suitable for delivery to the user device 105 through the appropriate channel, such as I/O app 505 or messaging app 505′. This can include the output generator 460 making determinations about whether a response should be text only or include an image and, if an image is to be returned, the appropriate image size. Image return processes can include generating a raster image from a vector image and resizing a previously generated raster image. The specific content and format of the response can vary depending on various factors including the type of data link 505/505′ being used by the user device 105 to communicate with the server 110. The generated response can then be sent to the user, generally over the same communication method through which the user's message was received at the server.

Output generator 460 can initially check if the data channel being used to communicate with the user is compatible with image transmission, or is a narrow bandwidth of otherwise text-only messaging system and also for other user device attributes relevant to the response. A general channel capacity (such as low, medium, or high) can be estimated, e.g., by the account management engine 450 or other input processor, based on the manner in which an incoming request is received and relevant information can be stored in the system 100 as part of receipt of an incoming message.

If a user communication is over an SMS or other text messaging system 505′, the server system 110 can designate that a response should be text-only. If the messaging system is of a type that allows images to be sent, the image size constraints of the particular messaging system can be determined. Likewise, at least for some types of communication, metadata can be included in the message indicating the type of user device at issue, such as a cell phone, tablet, or PC., and this can be associated with a typical display size and resolution. Messaging metadata can also indicate the type of connection a user device has, such as, GSM (2G), 3G, LTE (4G) etc.

Messaging system type, image size constraints of messaging system, and typical display resolution can be used by the output processor to format a returned image in a manner most appropriate for the communication channel and user device at issue. Images stored in vector format can be easily used to generate raster image of an appropriate resolution for the user device and that is compatible with the constraints of the messaging system. In some cases, a messaging system may be able to support transfer of large size images but the user's connection itself may be limited so that receipt of large image file data would take a long time. A maximum user image size can be specified based on the user's connection type, with larger image sizes sent for connections with faster bandwidths to avoid undesired delay in receiving the image which a user may perceive as a problem with the operation of the server 110 itself. The maximum user image size can also be a function of the type of user device.

If a determination is made that the communication protocol does not support image communication then delivery of the image itself can be deferred and the URL link associated with the generated response and/or the assigned image ID is returned to the user. The URL and/or image ID can be used in a subsequent request to the server, from the same of a different user device 105, and which may be associated with the same or a different user, to retrieve the referenced image at a later time. For example, a user about to give a presentation may want to generate a chart of some data but lack a suitable cell phone or Wi-Fi connection. They can still send the request to the system 100 via a text message. The returned URL or image ID can then be accessed when the user is in a better coverage area. Or the URL/ID can be copied and texted by the user to a third party that does have access to a suitable device, such as a PC with a wired internet connection.

In an embodiment, the output generator 460 can also determine a minimum image presentation resolution and compare it a determined maximum image size for the given user device and/or data link to the server. If the minimum presentation resolution exceeds the maximum user image size the output generator 460 can revert to sending a text message with the URL and/or ID allowing image retrieval by the user at a later date or immediately thereafter (in a follow-up request sent to the server 110) with the knowledge that delivery may be delayed.

In an embodiment, the message protocol can include a keyword allowing a user to optionally designate a preferred image size. If the container includes an image size designation this can act as an override to automated image size selection by the output generator 460. If a designated image size is lower than the minimum presentation resolution the output generator 460 can include with the returned image (in that communication or a follow-up to the user) an indication that the specified image size is not sufficient to accurately display the requested visualization. The user can subsequently send a request to the server asking for the image be returned at a higher resolution.

If the system 100 is configured to maintain user accounts, a user can specify alternative delivery methods for requested image visualizations. For example, a user may request that responses be returned via e-mail to a specified address. Such an e-mail response, generated from the output generator 460, can be in addition to a response that would normally be returned directly to the user device over the initiating connection type. Alternatively, the substantive response could be sent by e-mail and the user could receive a simple confirmation response indication their request was successfully handled. In an embodiment, the output generator 460 can be configured to select an appropriate image size to return to the user based on the connection type, user device type, etc., as discussed above, and if a user has specified an e-mail address, also send the response to the e-mail address with the visualization at a high resolution or other size that can be specified as part of a user profile. The communication protocol could also include a keyword allowing a user to specify an e-mail address to which results of that request should be returned and this can be processed in a manner similar to that where the email is specified in a predefined user profile.

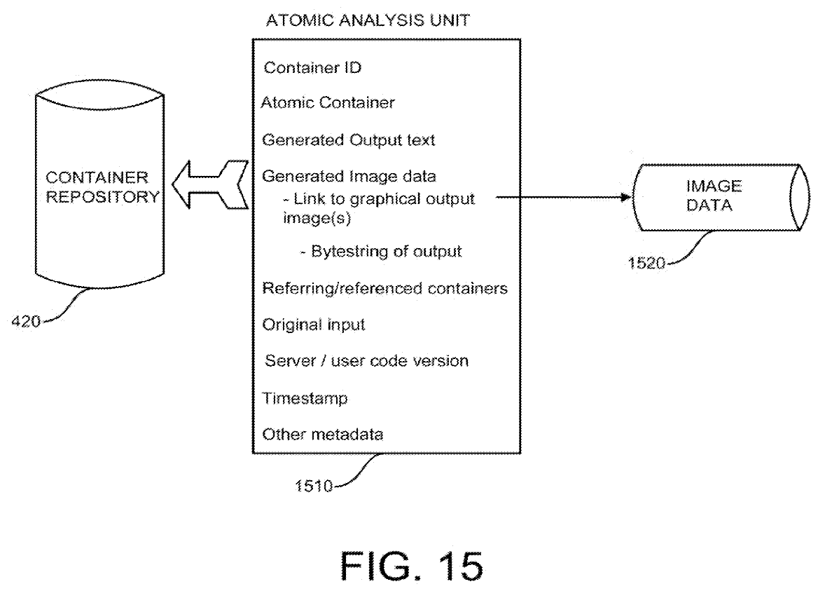

As noted previously, the atomic container, the generated image and/or other responsive data or links thereto, as well as additional metadata can be stored in a combined atomic analysis unit (AAU) data record 1510 that can be stored in storage 125. FIG. 15 is an example of such an AAU data record 1510 and the data that can be stored in that record. The records 1510 can be stored within the container repository 420 and various technique and methodologies known to those of skill in the art can be used to store AAU data record information within a database linked to the container ID as shown herein.

Each AAU record 1510 has a unique container ID that can be used to reference the associated atomic container and the generated output. The generated output from processing the atomic container can be stored directly within the record or links provided to external data. For example, output text could be stored in the record 1510 while generated images, such as a requested graph, could be stored in a separate image data repository 1520 with links to the appropriate image(s) stored in the record 1510. Various metadata can also be stored, such as details on any referenced atomic containers used to generate the atomic container of the specific record, the original user input, back references to any other containers that were generated with reference to this one, along with other information that might be useful in recreation, audit, or analysis, such as the code version of the server and/or user systems at the time of the request and a timestamp.

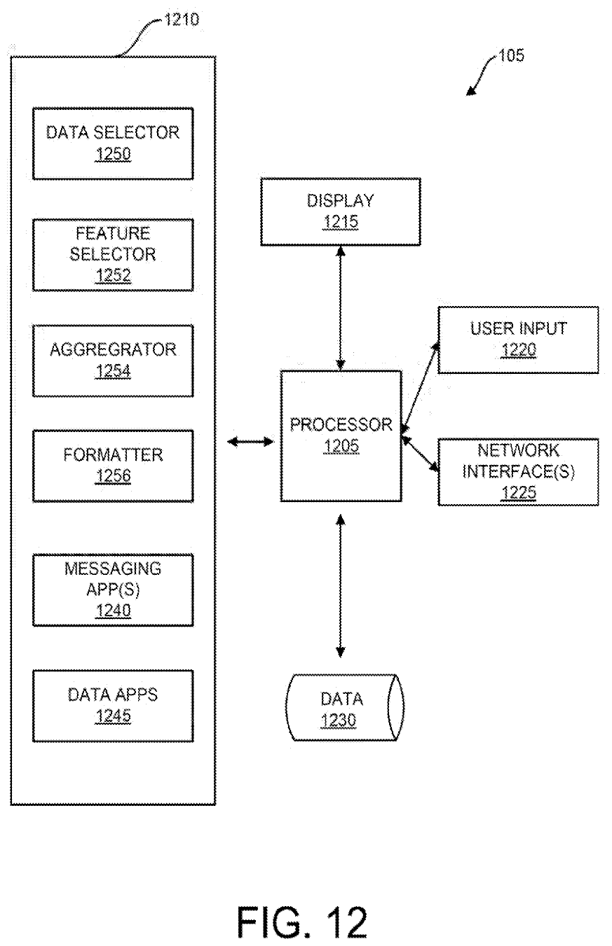

FIG. 12 is a high-level block diagram of the components of a user device 105 Device 105 can be a smart device, such as a cell-phone or tablet device although other computing devices, such as a laptop or desktop computer can be used as well. Device 105 comprises a processor 1205 that executes computer software stored in a program memory 1210. A display 1215 provides a visual output. Data can be entered into a user input device 1220, which can be keyboard, touchscreen, or other input. One or more network interfaces 1225 provide data connections to external devices, including to the server 110. Network interfaces 1225 can include a cellular interfaces, Bluetooth, WiFi or other wireless connection. A wired data connection, such as to a wired Ethernet network, can also be provided.

Device 105 includes a memory which can include program memory 1210 and data memory 1230. The memory can be combined or segregated. Memory 1210, 1230 can also include remote storage, such as cloud storage.

Program memory 1210 has various Apps stored therein. A messaging application 1240 can be used to provide based communication with the server. The messaging app 1240 can be a basis SMS text messaging function integrated with the device's operating system or a separate messaging app, which may allow communication with the server through various networks and with various degrees of flexibility. Other messaging applications that can be used include Facebook Messenger, WhatsApp, Signal, Telegram, WeChat, and Slack. To make use of the system 100 through messaging the server 110 will need appropriate support for the messaging app used on the user device 105. In a further embodiment, the user device 105 can interact with the server 110 via an internet web page interface to a webpage hosted by the server 110 instead of a messaging application.

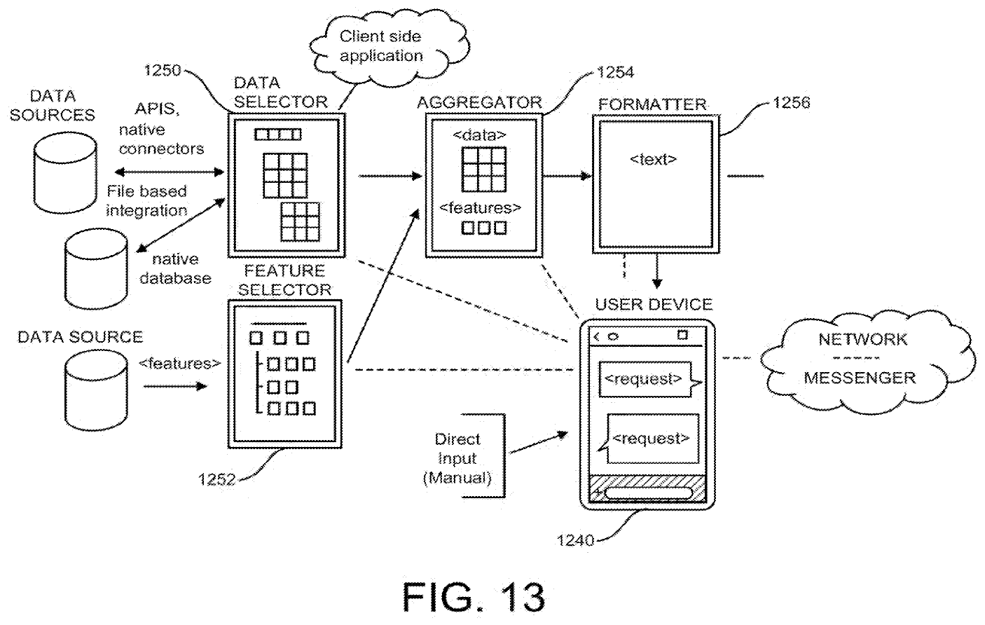

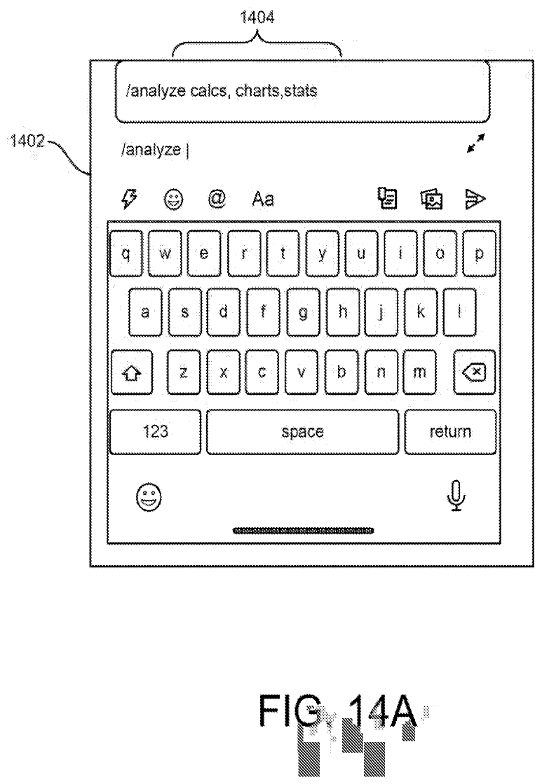

With further reference to FIG. 12 and the high-level flow diagram of FIG. 13, showing functional data flow of operation of a user device 105, in the most basic implementation a user can manually input the text into the messaging app 1240 that is to be sent to the server. For example, a user could type the container data as shown in FIG. 3b and/or cut and paste text from another application or data source.

In an embodiment, the user device can also include a front-end software that can guide the selection and collection of table data, building the generating a request to send to the server, and apply formatting rules. A data selector application 1250 provides functionality to allow a user to select data from a plurality of sources. Data selector 1250 can include APIs allowing it to interact with other applications on the user device where relevant information may be stored, such as in resident document files, as collected and stored by custom data collection apps e.g., connected to sensing devices, or as may be stored by other data processing applications, such as a local spreadsheet. It can also allow a user to cut and paste data from a local application, such as copying data from a table from a document stored locally or in a cloud.

Feature selector 1252 is a client-side application that provides an interface to the user to assist in the selection of features and options of analysis. The aggregator 1254 operates to merge the data and features as part of constructing the message to be sent to the server. Additional options selected by a user can be added to the aggregated message as well. Formatter 1256 operates to generate a body of text with a defined syntax and semantics. In one embodiment the formatter 1256 stores the generated message text, e.g., in a local note and a user can further edit and then manually send the text to the server 110, e.g., via a text messaging app. The text can be a minimal format atomic container message. Alternatively, the message generated by formatter 1256 can include a richer set of data that reflects the workflow followed by the user in building the request and from which the atomic container can be generated. Formatter 1256 could also directly initiate sending the generated message. In a particular embodiment, as the user interacts with the data selector and feature selector, that interaction is used to build a complete workflow reflecting the user's interaction with the data and feature selectors 1250, 1252.

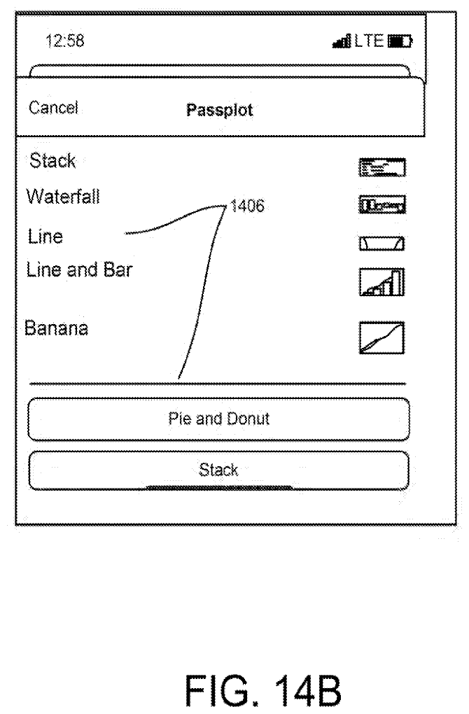

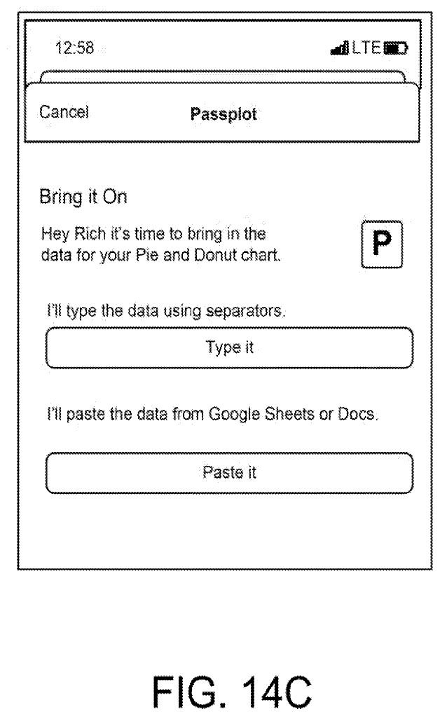

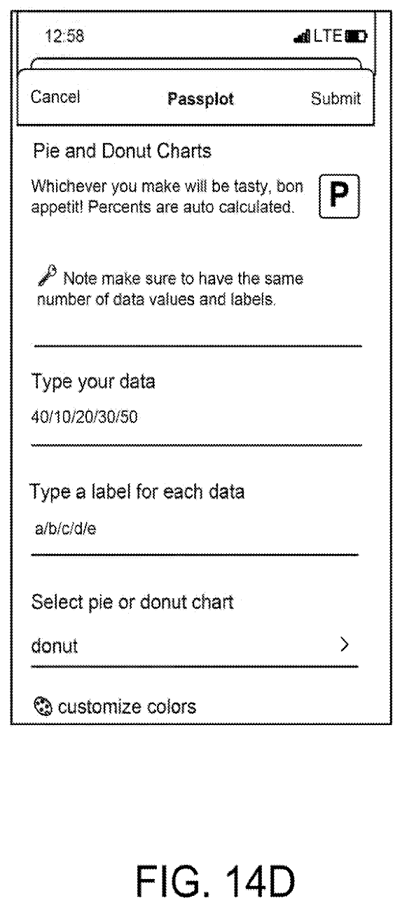

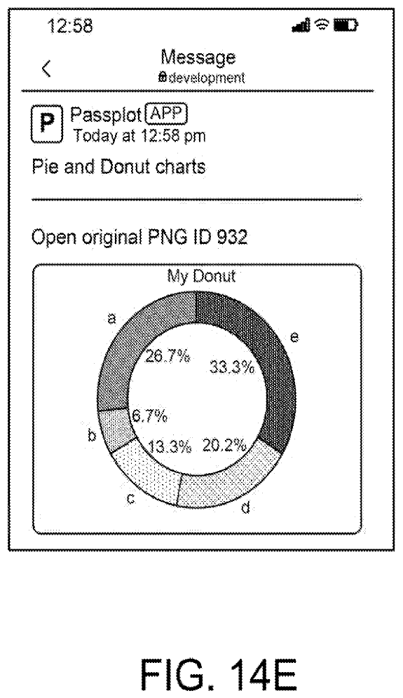

A sample guided input process is shown in FIGS. 14a-14d which show representative screen displays. With reference to FIG. 14a, a user indicates that they want to start an analysis, such as by typing “/analyze” (1402) and is then presented with various types of analysis available (1404). Selecting a particular analysis type will bring up a display of the various options. For example, selection of “charts” can result in a screen as shown in FIG. 14b that presents the various types of charts available (1406).

After selecting a chart, the user can be presented with one more screens to guide entry of the relevant data. FIG. 14c is a first data entry screen following a selection of a Pie and Donut Chart. As shown, a user can be given the option of typing or pasting in the data. Selection of the typing option leads to an input display, such as shown in FIG. 14d, with data fields into which the relevant data and labels can be entered and other options selected.

In one embodiment, the workflow can be processed on the user device within the formatter and the atomic container text is sent. For the example of FIGS. 14a-d, the atomic container text could be: “Method(donut) data(40/10/20/30/50) labels(a/b/c/d/e) title(My Donut).” An example of a graphical response from the server 110 in response to this is shown in FIG. 14e.

In an alternative embodiment, the text is formatted and sent as an expanded object that can be processed by the workflow processor 452 on the server 110 to generate the atomic container. The workflow codifies the analytics as a combination of both the software, the user, and the use parameters. The workflow object can therefore provide an analytic product which is fully specified and can be uniquely indexed to a specific user at a specific location and time with a specific intention.

By sending the workflow from which an associated atomic container can be created, the container protocol on the server side can be varied without having to alter the operation of the client. Similarly, the workflow processing functionality also allows multiple different user platforms and APIs to be used to generate messages sent to system. For example, the Slack messaging application, which can integrate messages from multiple other messaging platforms, includes an API that allows developers to build bots and bot users for Slack and this can be used to provide a communication mechanism between a user device and the system. At the end of a guided data entry workflow, when the user presses “submit”, a JSON object can be is generated that includes the various design kit implemented features (such as buttons, dropdowns, free text, etc.) and this sent to the server. The workflow processing can then recreate the requested atomic container accordingly and in compliance with the current container protocol implemented on the server.

In addition, the same workflow can also be used for different purposes. The analytics workflow can include all the information needed for analytics operationalization: It has everything the code needs to make an analytics product; the code has everything it needs to convert the container into an analytics product; the relationship of workflow and work product is one to one and explicit while also remaining complete and accurate. Further, it is a single intent unit for analytics.

In an embodiment, a workflow object from which an atomic container can be built has two parts. A first part is a text string, which defines inputs for the analytic workflow, including the type of workflow, associated options, and all the required raw data for execution including (a) the method of analysis; (b) the features/options of the method; and the raw data (c) as manually typed and delimited which is useful for small data sets; or (d) as a ‘texted table string equivalent” that is later reconstructed through the parsing layer and which is useful for denser data sets. A second part can include additional numeric or text metadata that identifies one or more of (a) the user/requestor of the analysis; (b) a time and place of the request; (c) time and place of delivery of the analytics product (e.g., in a collaboration channel), the URL of the output media, the version of the code, or other information. Support for including the second set of data in an atomic container could be provided as well.

The totality of the analytics workflow can be stored in different ways. For example, the workflow object can be stored as a structured database (such as in relational tables), so that each analytics workflow object is a specified join of different tables. Alternatively, it can be stored as a partially structured or unstructured database and which can be integrally stored as a compete structured data object, such as in JSON, XML, html, or other formats, and which can be sent over a variety of interfaces, most commonly over an Internet web application.

More complex analytics work products can built out of multiple atomic containers or workflow objects. For example, an analytics visual dashboard is essentially a collection of independent objects, each of which produces an analytics product, a visualization, of known inheritance. For example, a side by side donut chart, a run chart, a stack chart, and a waterfall chart. As another example, a plurality of users can run a regression analysis (each is a container) and a further user generates a new workflow object that produces a histogram showing the strengths of all the regression analyses (mixing of the individual workflows, of known inheritances).

As discussed above, the atomic containers and workflows can also be used as a source to build a dataset to use in training an AI system that can provides recommendations to a future user based on prior traceable relationships between workflow objects and/or resulting containers and their analytics products.

Various aspects, embodiments, and examples of the invention have been disclosed and described herein. Modifications, additions and alterations may be made by one skilled in the art without departing from the spirit and scope of the invention as defined in the appended claims.

1. A computer implemented method comprising the steps of:
receiving over a messaging system a first request for a data visualization from a first user device, the first message comprising a text string compliant with a predefined protocol and including first table data identified by at least one keyword of the protocol;
storing the first message as a first atomic container in a container database;
parsing the first atomic container to extract the first table data;
reconstructing a first table geometry based on the first table data;
generating a first graphical representation of the first table data in accordance with the first table geometry; and
sending to the first user over the messaging system at least one of the first graphical representation and a unique reference to the first graphical representation.

2. The method of claim 1, the step of reconstructing the first table geometry comprising the steps of:
parsing the first table data to identify numeric data values, alphanumeric data values, and a number of binary indicators;
determining a plurality of possible table geometries as a function of the number of numeric data values, the number of alphanumeric data values, and the number of binary indicators; and
evaluating at least one of the plurality of possible table geometries using the second table data to identify a unique table geometry consistent with the second table data; and
using the unique table geometry as the first table geometry.

3. The method of claim 1, wherein the step of parsing comprises extracting a first data visualization type identified by a visualization type keyword in the first message;
the step of generating the first graphical representation of the first table data comprising generating a graphical visualization of the table data in accordance with the first data visualization type.

4. The method of claim 1, further comprising the steps of:
accessing a container database comprising a plurality of atomic containers each comprising a text string compliant with the predefined protocol and that includes respective table data and a respective data visualization type; and
determining a first data visualization type for the first table data based on the first table data and on information in the container database;
the step of generating the first graphical representation of the first table data comprising generating a graphical visualization of the table data in accordance with the first data visualization type.

5. The method of claim 1, the messaging system comprising a text messaging system,
the step of sending to the first user comprising sending the unique reference to the first graphical representation.

6. The method of claim 5, further comprising the steps of:
receiving a second request from an external device, the second request including the unique reference to the first graphical representation; and,
responsive to receipt of the second request sending the first graphical representation to the external device;
wherein the external device comprises one of the first user device and a second user device.

7. The method of claim 1, the first atomic container specifying a first visualization format;
the step of generating a first graphical representation comprising generating the first graphical representation in the first visualization format;
the method further comprising the steps of:
receiving a second message from an external device, the second message comprising second table data and referencing one of the first atomic container and the first graphical representation;
retrieving the first atomic container from the container database;
generating a second atomic container comprising the second table data and the first visualization format from the first atomic container;
storing the second atomic container in the container database;
parsing the second atomic container to extract the second table data; and
generating a second graphical representation of the second table data in accordance with the visualization format specified in the second atomic container; and
sending the second graphical representation to the external device;
wherein the external device comprises one of the first user device and a second user device.

8. A computer implemented method comprising:
receiving over a first communication system a first request for a data visualization from a first user device, the first message comprising a first workflow and first table data, the first message not being compliant with a predefined protocol for presenting in a text format requests for visualization of data;
evaluating the first workflow to generate a first atomic container comprising text describing a workflow for data visualization compliant with the first protocol, the first atomic container comprising the first table data;
parsing the first atomic container to extract the first table data;
determining a first visualization format for the first atomic container;
generating a first graphical representation of the first table data in the first visualization format; and
sending to the first user over the first communication system at least one of the first graphical representation and a unique reference to the first graphical representation;
receiving over a second communication system different from the first a second request for a data visualization from a second user device, the second message comprising a second workflow and second table data, the second message complaint with the protocol, and the second being a second atomic container;
parsing the second atomic container to extract the second table data;
determining a second visualization format for the second container;
generating a second graphical representation of the second table data in the second visualization format; and
sending to the second user over the second communication system at least one of the second graphical representation and a unique reference to the second graphical representation.

9. The method of claim 8, further comprising the step of:
reconstructing a table geometry for the second atomic container based on the second table data;
the graphical representation of the second table data being dependent on the reconstructed table geometry.

10. The method of claim 9, the step of reconstructing the table geometry comprising the steps of:
parsing the second table data to identify numeric data values, alphanumeric data values, and a number of binary indicators;
determining a plurality of possible table geometries as a function of the number of numeric data values, the number of alphanumeric data values, and the number of binary indicators; and
evaluating at least one of the plurality of possible table geometries using the second table data to identify a unique table geometry consistent with the second table data.

11. The method of claim 8, further comprising the steps of saving the first atomic container and the second atomic container in a container database, each respective atomic container in the container database having a unique ID.

12. The method of claim 11, comprising the steps of:
receiving a third message from a third user comprising third table data and a reference to the first atomic container;
retrieving the first atomic container from the container database;
creating a third atomic container comprising the first atomic container with the first table data replaced by the third table data;
storing the third atomic container in the container database;
generating based on the content of the third atomic container a graphical representation of the third table data in the first visualization format; and
sending to the third user at least one of the third graphical representation and a unique reference to the third graphical representation.

13. The method of claim 8,
the first workflow being received via a first communication type;
the second workflow being received via a second communication type;
the bandwidth of the first communication type being larger than a bandwidth of the second communication type; and
wherein an amount of text in the first message is greater than an amount of text in the first container.

14. The method of claim 8, wherein the first message is a structured text base object, the first communication system comprises an HTTP compliant internet connection, and the second communication system comprises a messaging application.

15. The method of claim 14, wherein the messaging application is a cellular text messaging system

16. A system comprising:
a computer processor;
a data interface in communication with the processor and through which the system can communicate with remote devices using one or more data communication systems;
a container database; and
a computer memory having computer instructions stored therein that, on execution by the processor causes the system to:
receive a first atomic container comprising text compliant with a predefined protocol for presenting in a text format requests for visualization of data, the first atomic container being associated with a first remote device;
store the first atomic container in the container database;
parse the first atomic container in accordance with keywords specified in the protocol;
responsive to a determination that the first atomic container comprises a request to visualize table data specified in the first atomic container:
extract first table data from the first atomic container;
reconstruct a first table geometry from the first table data;
determine a data visualization type;
create a graphical representation of the first table data in accordance with the data visualization type; and
send one of the graphical representation and a unique reference to the graphical representation to a first user device.

17. The system of claim 16, further comprising computer instructions that, on execution by the processor, causes the system to:
receive from the first user device a first message including a workflow therein that includes a request for visualization of data, the workflow comprising a text string having a length;
using the first message as the first atomic container if the first message is compliant with the protocol;
in response to a determination that the first message is not compliant with the protocol, generating from the workflow a modified text string including the request for visualization of data and that is compliant with the protocol, and using the modified text string as the first atomic container, wherein the modified text string has a length that is less than a length of the workflow text string.

18. The system of claim 16, further comprising computer instructions that, on execution by the processor, causes the system to:
responsive to a determination that the first atomic container comprises a reference to a second atomic container stored in the container database:
retrieve the second atomic container;
replace at least a portion of content in the second atomic container with content from the first container to create a modified atomic container; and
use the modified atomic container as the first container.

19. The system of claim 16, further comprising:
an artificial intelligence (AI) network, the AI network trained using a dataset comprising a plurality of atomic containers each of which complies with the protocol and includes text specifying respective table data and a respective data visualization type, the AI network trained to predict visualization type from specified table data;
the computer code that causes the computer to determine a data visualization type comprising computer code that causes the computer to input at least a portion of the first table data to the AI network and to receive from the AI network a predicted data visualization type.

20. The system of claim 16, comprising computer code that causes the computer to:
receive a message from an external device;
in response to a determination that the message includes the unique reference to the graphical representation, send to the external device the graphical representation.

21. The system of claim 16, the computer code that causes the computer to send one of the graphical representation and a unique reference to the graphical representation comprising computer code that causes the computer to select whether to send the graphical representation or the unique reference to the graphical representation based on the type of data interface over which the first message is received.

22. The system of claim 16, the computer code that causes the computer to send one of the graphical representation and a unique reference to the graphical representation comprising computer code that causes the computer to send the unique reference to the graphical representation to the first remote device using a first data communication system and to send the graphical representation using a second data communication system different from the first communication system to an address associated with the first user device.
